(19) United States
(12) Patent Application Publication
(10) Pub. No.: US 2013/0282786 A1
(43) Pub. Date: Oct. 24, 2013

(54) OPERATING METHOD AND MOBILE DEVICE

(71) Applicant: Chi-Lung Chen, Taipei City (TW)

(72) Inventor: Chi-Lung Chen, Taipei City (TW)

(73) Assignee: ASUSTEK COMPUTER INC., Taipei City (TW)

(21) Appl. No.: 13/855,718

(22) Filed: Apr. 3, 2013

Related U.S. Application Data
(60) Provisional application No. 61/635,308, filed on Apr. 19, 2012.

(30) Foreign Application Priority Data
Mar. 12, 2013 (TW) 102108690

(51) Int. Cl. H04L 29/08

(52) U.S. Cl. CPC H04L 67/10
USPC 709/201

(57) ABSTRACT

An operating method for a mobile device executing a first application is provided. In the operating method, the first application is analyzed to obtain a supporting display format of the first application. According to the supporting display format, whether the first application supports a displaying format of the mobile device. When the first application supports the displaying format, the first application is executed. When the first application does not support the displaying format, the execution of the first application is terminated or a second application corresponding to the first application and supporting the displaying format is searched through the internet according to a system setting of the mobile device. Further, when the second application is found through the internet according to the system setting, the second application is installed in the mobile device and executed.

### CROSS-REFERENCE TO RELATED APPLICATION

This application claims the priority benefits of U.S. provisional application Ser. No. 61/635,308, filed on Apr. 19, 2012 and Taiwan application serial no. 102108690, filed on Mar. 12, 2013. The entirety of each of the above-mentioned patent applications is hereby incorporated by reference herein and made a part of this specification.

### BACKGROUND OF THE INVENTION

1. Field of Invention

The present disclosure relates to an execution method of an application and a mobile device. More particularly, the present disclosure relates to a method for executing an application on a hybrid portable device.

2. Description of Related Art

With the development of technologies, portable devices, such as phones, smart phones, personal digital assistant (PDA) phones, tablet personal computers (tablet), and notebook computers, have been broadly used in our daily life. Operating systems on these portable devices, such as Apple iOS and Google Android, allow users to install third-party applications. Namely, a user can directly download third-party applications onto a portable device through the Internet.

The fields of aforementioned application are various include business, travel, personal management, project management, etc. Some applications are designed for particular display format. For instance, some applications only support the display formats of the tablet and cannot support the display formats of the smart phones or some applications only support the display formats of the smart phones but cannot support the display format of the tablet. Hence, when the application which is designed for a particular display format is executed in the portable device of which the display device is not supported by the application, usually, the application cannot be executed normally or the application may be abnormally terminated.

### SUMMARY OF THE INVENTION

The disclosure provides an operating method for a hybrid portable device, wherein the hybrid portable device is assembled by a handheld device and an electronic device and the electronic device has a display format. In the operating method, a first application is analyzed to obtain a supporting display format of the first application when the hybrid portable device executes the first application. According to the supporting display format, it is determined whether the first application supports the display format. The first application is executed when it is determined the first application supports the display format. When it is determined the first application does not support the display format, optionally, an execution of the first application is terminated or a second application which is corresponding to the first application and supports the display format is searched through Internet according to a system setting of the handheld device.

The present disclosure also provides a hybrid portable device. The hybrid portable device comprises an electronic device and a handheld device coupled to the electronic device and having a display format. The handheld device comprises a storage unit and a processor. The storage unit is used for storing an application. The processor is used for analyzing the first application to obtain a supporting display format of the first application, determining whether the first application supports the display format according to the supporting display format, executing the first application when it is determined the first application supports the display format, optionally terminating an execution of the first application or searching a second application which is corresponding to the first application and supports the display format through Internet according to a system setting of the handheld device when it is determined the first application does not support the display format and executing the second application.

Accordingly, in the operating method and the mobile device of the present case, the before the application is executed, the application is analyzed to obtain it's hardware supporting abilities. When the hardware supporting abilities shows that the application does not support the display device of the mobile device, the execution of the application can be terminated immediately or other applications which are corresponding to the application and support the display format of the display device are searched through the Internet. Hence, the problems of suddenly interrupting the execution of the application due to the application not supporting the display format can be overcome.

It is to be understood that both the foregoing general description and the following detailed description are exemplary, and are intended to provide further explanation of the disclosure as claimed.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a process flow diagram, schematically illustrating an operating method according to one embodiment of the disclosure.

FIG. 2 is a schematic diagram showing a mobile device according to one embodiment of the disclosure.

FIG. 3 is a process flow diagram, schematically illustrating the steps of terminating the execution of the first application or searching the second application through the Internet according to the system setting of the mobile device according to one embodiment of the present disclosure.

FIGS. 4A through 4B are schematic diagrams of a hybrid portable device before and after assembly according to one embodiment of the disclosure.

### DESCRIPTION OF THE PREFERRED EMBODIMENTS

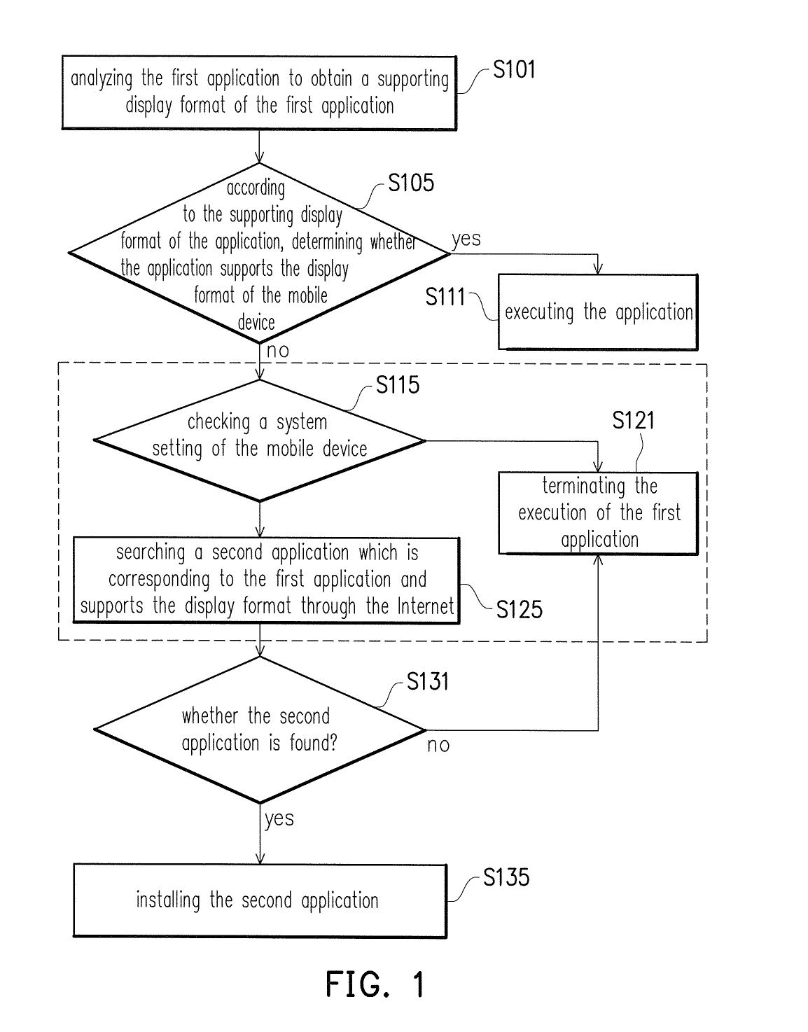

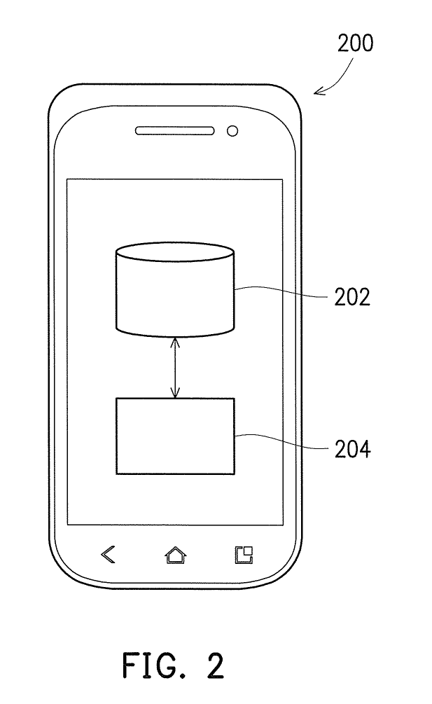

FIG. 1 is a process flow diagram, schematically illustrating an operating method according to one embodiment of the disclosure. FIG. 2 is a schematic diagram showing a mobile device according to one embodiment of the disclosure. As shown in FIG. 1 and FIG. 2, the mobile device 200 of the present embodiment comprises a storage unit 202 and a processor 204. The mobile device 200 can be, for example, a phone, a smart phone, a personal digital assistant, a tablet personal computer (tablet or a notebook). The processor 204 can be, for example, a micro-controller, an embedded controller or a central processing unit (CPU).

After receiving an execution signal for executing a first application, in the step S101, the processor 204 analyzes the first application to obtain a supporting display format of the first application. That is, the mobile device 200 of the present embodiment allows the user to download various applications with different types. However, before the application is executed, the processor 204 analyzes the application in advance to recognize the display format which is supported by the application. Then, in the step S105, the processor 204, according to the supporting display format of the application, determines whether the application supports the display format of the mobile device 200. The aforementioned supporting display format comprises the display format information (such as resolution of the display device, display dimensions, display color depth, etc.) indicating that which format or system of mobile device is supported by the application.

For instance, as for the tablet PC-specific application, the supporting display format records that the resolutions which the application supports include 1024×768, 2048×1536 or 2560×1600 or records that the display dimensions which the application supports include 7″, 10.1″ or 11.6″. Moreover, as for the phone-specific application, the supporting display format records that the resolutions which the application supports include 480×320 or 960×640 or records that the display dimensions which the application supports include 3.5˜3.8″ or 4.5˜4.9″. Further, as for the application which supports both of the tablet PC and mobile, the supporting display format records that the resolutions which the application supports include 480×320, 960×640 and 1024×768 or records that the display dimensions which the application supports include 3.5˜3.8″, 4.5˜4.9″, 7″, 10.1″ or 11.6″. Since the application can be the tablet specific application only supporting the table, the phone-specific application only supporting the phone or a common application supporting both of the tablet PC and phone, the supporting display format of the application is analyzed before the application is executed and, in the following steps, it is determined whether the application is continuously executed according to the supporting display format of the application.

In the step S111, when the supporting display format shows that the application supports the display format of the mobile device 200, the processor 204 starts to execute the application. However, in the step S115, when the supporting display format shows that the application does not support the display format of the mobile device 200, the processor 204 further checks a system setting of the mobile device in order to optionally terminate the execution of the first application (step S121) or to search a second application which is corresponding to the first application and supports the display format through the Internet (step S125).

In the step S131, according to the system setting, the processor 204 determines whether the second application is found. When the second application is not found, the execution of the first application is terminated (step S121). Moreover, when the second application which is corresponding to the first application and supports the display format of the mobile device, in the step S135, the processor 204 install the second application.

In another embodiment, the storage unit 202 of the mobile device 200 further stores a flag corresponding to the supporting display format of the first application. For instance, the supporting display format of the application records that the resolution the application supports is 1024×768, which means the application only supports the device (such as the tablet PC) having the display device with the resolution of about 1024×768. Hence, the flag of the application is set to be a first value “P” (which will be simplified as the first value P in the following description). Moreover, the supporting display format of the application records that the resolution the application supports is 480×320, which means the application only supports the device (such as the phone) having the display device with the resolution of about 480×320. Hence, the flag of the application is set to be a second value “F” (which will be simplified as the second value F in the following description).

In the present embodiment, if the content recorded in the supporting display format of the application only supports the tablet, the flag of the application is set to be the first value P. If the content recorded in the supporting display format of the application only supports the phone, the flag of the application is set to be the second value F. Of course, the application can also supports other display devices with different display formats and the flag of the application can be accordingly set to be the reference other than the aforementioned first value P and the aforementioned second value F. Furthermore, the present embodiment does not limit the expression of the flag. That is, the flag can be numbers, word strings, symbols or symbols which are capable of distinguish the supporting display format from one another.

Therefore, in the present embodiment, the step S101 in which the processor 204 analyzes the first application to obtain the supporting display format of the first application further comprises that the processor 204 obtain the flag corresponding to the first application from the storage unit 202. According to the supporting display format, the step S105 in which the processor 204 determines whether the first application supports the display format of the mobile device 200 further comprises that the processor 204 deter nines whether the first application supports the display format according to the flag.

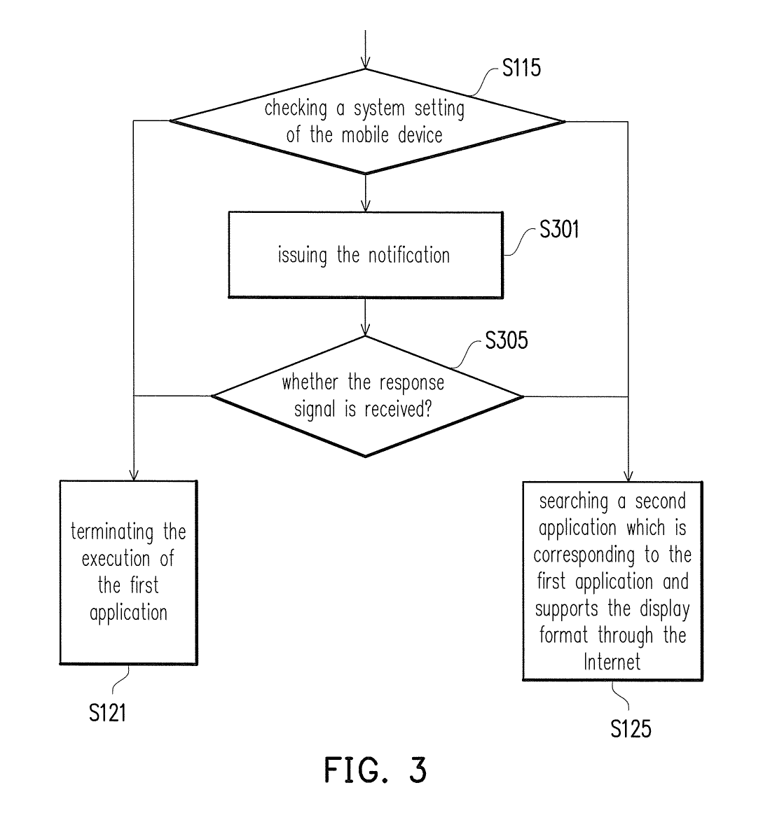

Moreover, in another embodiment of the present disclosure, the system setting of the mobile device 200 comprises immediately terminating the execution of the first application, immediately searching the second application through the Internet or issuing a notification so as to wait for a response signal. FIG. 3 is a process flow diagram, schematically illustrating the steps of terminating the execution of the first application or searching the second application through the Internet according to the system setting of the mobile device according to one embodiment of the present disclosure. As shown in FIG. 3, more clearly, the steps S115 through S125 shown in FIG. 1 in which the processor 204 terminates the execution of the first application or searches the second application through the Internet (as the steps in the dotted frame shown in FIG. 1) further comprise that when the system setting is to immediately terminate the execution of the first application, the processor 204 immediately terminates the execution of the first application (step S121). When the system setting is to immediately search the second application through the Internet, the processor 204 automatically searches the second application through the Internet (step S125). When the system setting is to issue a notification so as to wait for a response signal, the processor 204 issues the notification to warn the first application does not support the display format (step S301). Then, in the step S305, processor 204 determines whether the response signal is received (the response signal includes a terminating execution signal or a continuously searching signal). When the processor 204 receives the response signal and the response signal is the terminating execution signal, the processor 204 terminates the execution of the first application (step S121). Moreover, in the step S125, when the processor 204 receives the response signal and the response signal is the continuously searching signal, the processor 204 searches the second application which is corresponding to the first application and supports the display format of the mobile device 200 through the Internet (step S125).

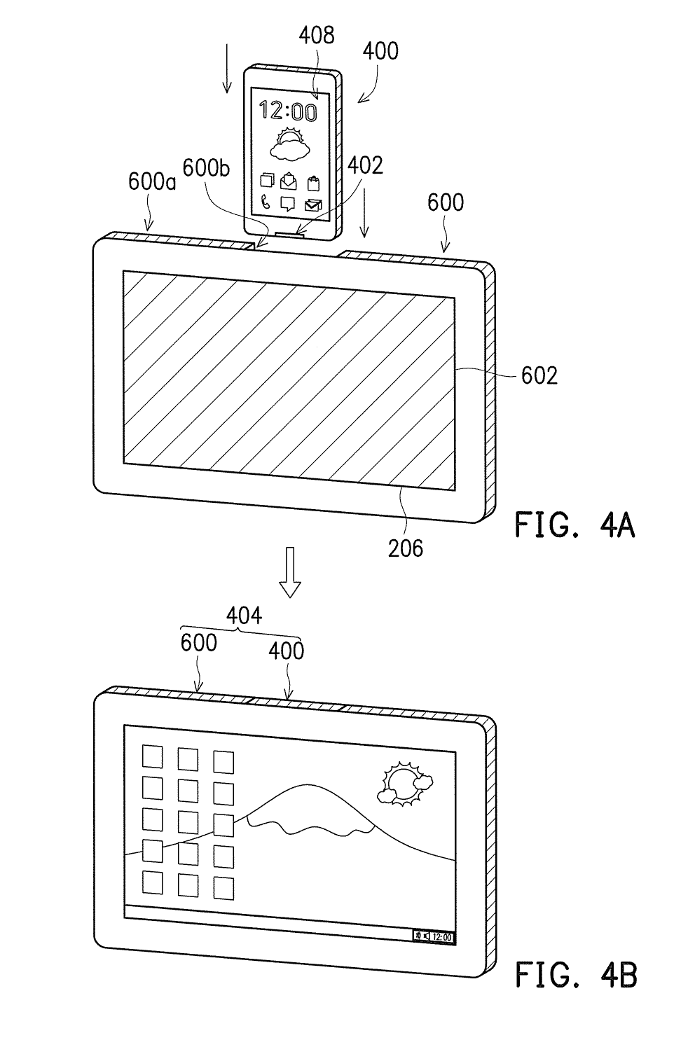

In the aforementioned embodiment, the mobile device can be a single mobile device or a hybrid portable device assembled by a handheld device and an electronic device. FIGS. 4A through 4B are schematic diagrams of a hybrid portable device before and after assembly according to one embodiment of the disclosure.

As shown in FIG. 4A and FIG. 4B, the handheld device 400 is coupled to an electronic device 600 through a connection port 402 so that the handheld device 400 and the electronic device 600 connected together form a hybrid portable device 404. The handheld device 400 can be, for example, a smart phone, a personal digital assistant, a tablet or a notebook. The electronic device 600 can be, for example, an electronic device which has the display device and receives the control signal sent from the handheld device 400 so as to display frames on its display device 602 after the electronic device 600 is coupled to the handheld device 400.

It should be noticed that the display format of the handheld is different from the display format of the electronic device (i.e. the display format of the electronic device). Noticeably, in the hybrid portable device 404 of the present embodiment, the handheld device 400 is coupled to the electronic device 600 in an embedded form in which the handheld device 400 is embedded in the electronic device 600. Accordingly, in the present embodiment, the major display device of the hybrid portable device 404 is the display device 602 of the electronic device 600. That is, when the mobile device is the hybrid portable device 404, the display format of the mobile device is the display format of the display device of the electronic device (i.e. the display format of the display device 602).

For instance, in the present embodiment, the handheld device 400 (such as the smart phone, the personal digital assistance, etc.) has the display device 408 with the resolution of about 480×320 or 960×640 and the electronic device 600 has the display device 602 with the resolution of about 1024×768, 2048×1536 or 2560×16000. The handheld device 400 moves along the slide 600b at the back surface 600a of the electronic device 600 opposite to the front surface on which the display device 602 is mounted so as to insert the slot (not shown) at the back surface 600a and to be couple with the electronic device 600 through the connection port 402 to form a hybrid portable device 404 (as shown in FIG. 4B). The hybrid portable device 204 can be, for example, a tablet personal computer.

Altogether, in the operating method and the mobile device of the present case, the before the application is executed, the application is analyzed to obtain it's hardware supporting abilities. When the hardware supporting abilities shows that the application does not support the display device of the mobile device, the execution of the application can be terminated immediately or other applications which are corresponding to the application and support the display format of the display device are searched through the Internet. Hence, the problems of suddenly interrupting the execution of the application due to the application not supporting the display format can be overcome.

It will be apparent to those skilled in the art that various modifications and variations can be made to the structure of the present disclosure without departing from the scope or spirit of the disclosure. In view of the foregoing descriptions, it is intended that the present disclosure covers modifications and variations of this disclosure if they fall within the scope of the following claims and their equivalents.

What is claimed is:

1. An operating method for a hybrid portable device, wherein the hybrid portable device is assembled by a handheld device and an electronic device and the electronic device has a display format, the operating method comprising:
analyzing a first application to obtain a supporting display format of the first application when the hybrid portable device executes the first application;
determining whether the first application supports the display format according to the supporting display format;
executing the first application when it is determined the first application supports the display format;
optionally terminating an execution of the first application or searching a second application which is corresponding to the first application and supports the display format through Internet according to a system setting of the handheld device when it is determined the first application does not support the display format; and
executing the second application.

2. The operating method of claim 1, wherein the electronic device or the handheld device includes a cell phone, a smart phone, a personal digital assistant, a tablet personal computer or a notebook computer.

3. The operating method of claim 1, wherein the hybrid portable device further comprises a storage unit storing a flag corresponding to the supporting display format of the first application.

4. The operating method of claim 1, wherein the system setting comprises immediately terminating the execution of the first application, immediately searching the second application through the Internet and installing the second application or issuing a notification so as to wait for a response signal.

5. The operating method of claim 4, wherein when the system setting is to issue the notification, the step of terminating the execution of the first application or searching the second application according to the system setting comprises:
issuing the notification to warn the first application does not support the display format;
terminating the execution of the first application when the response signal is received and the response signal is a terminating execution signal; and
searching the second application which is corresponding to the first application and supports the display format through the Internet when the response signal is received and the response signal is a continuously searching signal.

6. A hybrid portable device, comprising:
an electronic device;
a handheld device coupled to the electronic device, wherein the electronic device has a display format and the handheld device comprises:
a storage unit, storing a first application; and
a processor, analyzing the first application to obtain a supporting display format of the first application, determining whether the first application supports the display format according to the supporting display format, executing the first application when it is determined the first application supports the display format, optionally terminating an execution of the first application or searching a second application which is corresponding to the first application and supports the display format through Internet according to a system setting of the handheld device when it is determined the first application does not support the display format and executing the second application.

7. The hybrid portable device of claim 6, wherein the electronic device or the handheld device includes a smart phone, a personal digital assistant, a tablet or a notebook.

8. The hybrid portable device of claim 6, further comprising a storage unit storing a flag corresponding to the supporting display format of the first application.

9. The hybrid portable device of claim 6, wherein the system setting comprises immediately terminating the execution of the first application, immediately searching the second application through the Internet or issuing a notification so as to wait for a response signal.

10. The hybrid portable device of claim 9, wherein when the system setting is to issue the notification, the processor terminating the execution of the first application or searching the second application according to the system setting comprises:
issuing the notification to warn the first application does not support the display format, terminating the execution of the first application when the response signal is received and the response signal is a terminating execution signal, and searching the second application which is corresponding to the first application and supports the display format through the Internet when the response signal is received and the response signal is a continuously searching signal.
